(19) United States
(12) Patent Application Publication
(10) Pub. No.: US 2025/0196893 A1
(43) Pub. Date: Jun. 19, 2025

(54) APPARATUS FOR CONTROLLING A VEHICLE AND A METHOD THEREOF

(71) Applicants: HYUNDAI MOTOR COMPANY, Seoul (KR); KIA CORPORATION, Seoul (KR)

(72) Inventors: Dae Young Kim, Gwangmyeong-si (KR); Beom Jun Kim, Seoul (KR); Ji Hwan Park, Seoul (KR)

(73) Assignees: HYUNDAI MOTOR COMPANY, Seoul (KR); KIA CORPORATION, Seoul (KR)

(21) Appl. No.: 18/755,266

(22) Filed: Jun. 26, 2024

(30) Foreign Application Priority Data
Dec. 13, 2023 (KR) 10-2023-0181225

(51) Int. Cl. B60W 60/00

(52) U.S. Cl. CPC B60W 60/0053; B60W 2420/403; B60W 2540/10; B60W 2540/223; B60W 2540/225

(57) ABSTRACT

A vehicle control device includes an accelerator pedal that specifies an acceleration of a host vehicle, a steering wheel that specifies a driving direction of the host vehicle, and a processor. The processor may identify that the host vehicle is under autonomous driving control or under driver assistance control. The processor may control the host vehicle to allow the driver to take over control of driving of the host vehicle according to an amount of operation of the accelerator pedal when the host vehicle is under the autonomous driving control or under the driver assistance control based on at least one of identifying whether an amount of operation of an accelerator pedal is less than or equal to a value indicative of a specified amount of operation or identifying a driver input of gripping a steering wheel.

### CROSS-REFERENCE TO RELATED APPLICATION

This application claims the benefit of and priority to Korean Patent Application No. 10-2023-0181225, filed on Dec. 13, 2023, the entire contents of which are hereby incorporated herein by reference.

### TECHNICAL FIELD

The present disclosure relates to a vehicle control device and a vehicle control method. More specifically, the present disclosure relates to a technology for controlling a vehicle according to a driver input in a vehicle under autonomous driving control or under driver assistance control.

### BACKGROUND

With the advent of the 4th industrial revolution, competition to develop autonomous driving technology or driver assistance driving technology for vehicles is intensifying. As technology for adjusting driving routes and avoiding obstacles becomes more sophisticated, the scope and frequency of driver intervention required for driving is decreasing.

Even when autonomous driving or driver assistance driving is being performed, there is a need to control the vehicle through intervention of a human driver in certain situations. In certain situations, the driver's judgment may be faster and more reasonable than the judgment of the autonomous driving system or the judgment of a driver assistance system.

Research is being conducted to compare and weigh driving safety and driver convenience to determine which decision should be given priority: the driver's judgment, the autonomous driving system's judgment, or the driver assistance system's judgment.

### SUMMARY

The present disclosure has been made to solve the above-mentioned problems occurring in the prior art while advantages achieved by the prior art are maintained intact.

Aspects of the present disclosure provide a vehicle control device and a vehicle control method that identify whether an input for accelerating a vehicle is generated by a driver's intention based on a driver input of gripping a steering wheel during autonomous driving control or driver assistance control.

Aspects of the present disclosure provide a vehicle control device and a vehicle control method that identify whether an input for accelerating a vehicle is generated by a driver's intention based on the driver's gazes during autonomous driving control or driver assistance control.

Aspects of the present disclosure provide a vehicle control device and a vehicle control method that reduce an accident risk due to an input for accelerating a vehicle during autonomous driving control or driver assistance control.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control device is provided. The vehicle control device includes an accelerator pedal that specifies an acceleration of a host vehicle. The vehicle control device also includes a steering wheel that specifies a driving direction of the host vehicle. The vehicle control apparatus also includes a processor. The processor is configured to identify that the host vehicle is under autonomous driving control or under driver assistance control. The processor is further configured to control the host vehicle to allow a driver to take over control of driving of the host vehicle according to the amount of operation of the accelerator pedal based on at least one of i) identifying whether an amount of operation of an accelerator pedal is less than or equal to a value indicative of a specified amount of operation, when the host vehicle is under the autonomous driving control or under the driver assistance control or ii) identifying a driver input of gripping a steering wheel.

According to an embodiment, the processor may be configured to control the host vehicle to allow the driver to take over control of driving of the host vehicle according to the amount of operation of the accelerator pedal based on identifying that a value of deceleration at which the host vehicle is controlled under the autonomous driving control or under the driver assistance control is less than or equal to a specified value, when the host vehicle is under the autonomous driving control or under the driver assistance control.

According to an embodiment, the processor may be configured to control the host vehicle to allow the driver to take over control of driving of the host vehicle according to the amount of operation of the accelerator pedal based on identifying that gaze of the driver is directed toward a front of the host vehicle, when the host vehicle is under the autonomous driving control or under the driver assistance control.

According to an embodiment, the vehicle control device may further include a camera configured to acquire an image including the driver. The processor may be configured to identify a point to which the gaze of the driver is directed on a windshield of the host vehicle through the camera. The processor may further be configured to control the host vehicle to allow the driver to take over control of driving of the host vehicle according to the amount of operation of the accelerator pedal based on identifying that the point is included in a specified area on the windshield when the host vehicle is under the autonomous driving control or under the driver assistance control.

According to an embodiment, the processor may be configured to control the host vehicle to allow the driver to take over control of driving of the host vehicle according to the amount of operation of the accelerator pedal based on identifying that a value of acceleration identified according to the amount of operation of the accelerator pedal is greater than a value of acceleration at which the host vehicle is controlled under the autonomous driving control or under the driver assistance control, when the host vehicle is controlled to accelerate under the autonomous driving control or under the driver assistance control. The processor may also be configured to control the host vehicle to allow the driver to take over control of driving of the host vehicle according to the amount of operation of the accelerator pedal when the host vehicle is controlled to decelerate under the autonomous driving control or under the driver assistance.

According to an embodiment, the processor may be configured to control the host vehicle to allow the driver to take over control of driving of the host vehicle based on a value of acceleration identified according to the amount of operation of the accelerator pedal is greater than a threshold value.

According to an embodiment, the processor may be configured to identify a speed of the host vehicle. The value indicative of the specified amount of operation may have a correlation in which the value indicative of the specified amount of operation increases as the speed of the host vehicle increases.

According to an embodiment, the processor may be configured to identify a speed of the host vehicle. The specified value may have a correlation in which the specified value increases as the speed of the host vehicle increases.

According to an embodiment, the processor may be configured to identify the value of deceleration at which the host vehicle is controlled under the autonomous driving control or under the driver assistance based on at least one of a distance between the host vehicle and a preceding object, a difference between a speed of the preceding object and a speed of the host vehicle, or any combination thereof.

According to an embodiment, the processor may be configured to control the host vehicle to allow the driver to take over control of driving of the host vehicle according to the amount of operation of the accelerator pedal when the host vehicle is under the autonomous driving control or under the driver assistance control when the value of deceleration is determined based on at least one of a maximum speed set by the driver, a speed specified by law, a deceleration specified regardless of a preceding object of the host vehicle, or any combination thereof, even when the value of the deceleration at which the host vehicle is controlled is greater than the specified value.

According to an embodiment, the processor may be configured to identify a driver input through a touch sensor included in the steering wheel or identify the driver input through a torque sensor included in the steering wheel.

According to an embodiment, the processor may be configured to identify the value indicative of the specified amount of operation based on a range of the amount of operation of the accelerator pedal which a collision avoidance system is configured to operate. The collision avoidance system may be configured to provide a warning, brake the host vehicle, or control a driving direction of the host vehicle to avoid a collision between the host vehicle and an external object.

According to another aspect of the present disclosure, a vehicle control method is provided. The vehicle control method includes identifying that a host vehicle is under autonomous driving control or under driver assistance control. The vehicle control method also includes controlling the host vehicle to allow a driver to take over control of driving of the host vehicle according to an amount of operation of an accelerator pedal when the host vehicle is under the autonomous driving control or under the driver assistance control based on at least one of i) identifying whether the amount of operation of the accelerator pedal is less than or equal to a value indicative of a specified amount of operation or ii) identifying a driver input of gripping a steering wheel.

According to an embodiment, controlling the host vehicle to allow the driver to take over control of driving of the host vehicle according to the amount of operation of the accelerator pedal may include controlling the host vehicle to allow the driver to take over control of driving of the host vehicle according to the amount of operation of the accelerator pedal based on identifying that a value of deceleration at which the host vehicle is controlled under the autonomous driving control or under the driver assistance control is less than or equal to a specified value, when the host vehicle is under the autonomous driving control or under the driver assistance control.

According to an embodiment, controlling the host vehicle to allow the driver to take over control of driving of the host vehicle according to the amount of operation of the accelerator pedal may include controlling the host vehicle to allow the driver to take over control of driving of the host vehicle according to the amount of operation of the accelerator pedal based on identifying that gaze of the driver is directed toward a front of the host vehicle, when the host vehicle is under the autonomous driving control or under the driver assistance control.

According to an embodiment, controlling the host vehicle to allow the driver to take over control of driving of the host vehicle according to the amount of operation of the accelerator pedal based on identifying that the gaze of the driver is directed toward the front of the host vehicle may include i) identifying a point to which the gaze of the driver is directed on a windshield of the host vehicle through a camera and ii) controlling the host vehicle to allow the driver to take over control of driving of the host vehicle according to the amount of operation of the accelerator pedal based on identifying that the point is included a specified area on the windshield, when the host vehicle is under the autonomous driving control or under the driver assistance control.

According to an embodiment, controlling the host vehicle to allow the driver to take over control of driving of the host vehicle according to the amount of operation of the accelerator pedal may include controlling the host vehicle to allow the driver to take over control of driving of the host vehicle according to the amount of operation of the accelerator pedal based on identifying that a value of acceleration identified according to the amount of operation of the accelerator pedal is greater than a value of acceleration at which the host vehicle is controlled under the autonomous driving control or under the driver assistance control, when the host vehicle is controlled to accelerate under the autonomous driving control or under the driver assistance control. Controlling the host vehicle to allow the driver to take over control of driving of the host vehicle according to the amount of operation of the accelerator pedal may also include controlling the host vehicle to allow the driver to take over control of driving of the host vehicle according to the amount of operation of the accelerator pedal when the host vehicle is controlled to decelerate under the autonomous driving control or under the driver assistance.

According to an embodiment, controlling the host vehicle to allow the driver to take over control of driving of the host vehicle according to the amount of operation of the accelerator pedal may include controlling the host vehicle to allow the driver to take over control of driving of the host vehicle when a value of acceleration identified according to the amount of operation of the accelerator pedal is greater than a threshold value.

The vehicle control method may further include identifying a speed of the host vehicle. The value indicative of the specified amount of operation may have a correlation in which the value indicative of the specified amount of operation increases as the speed of the host vehicle increases.

The vehicle control method may further include identifying a speed of the host vehicle. The specified value may have a correlation in which the specified value increases as the speed of the host vehicle increases.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram showing a configuration of a vehicle control device, according to an embodiment of the present disclosure;

FIG. 2 is a block diagram specifically illustrating a configuration of a vehicle control device, according to an embodiment of the present disclosure;

FIG. 3 shows examples of conditions determined to reduce an accident risk in a vehicle control device or vehicle control method, according to an embodiment of the present disclosure;

FIG. 4 shows examples of conditions determined to reduce an accident risk in a vehicle control device or vehicle control method, according to an embodiment of the present disclosure;

FIG. 5 illustrates a flowchart of operation of a vehicle control device for determining whether to perform control according to a driver input in a vehicle control device or a vehicle control method, according to an embodiment of the present disclosure;

FIG. 6 illustrates a flowchart of operation of a vehicle control device for performing control according to a driver input in a vehicle control device or vehicle control method, according to an embodiment of the present disclosure; and

FIG. 7 illustrates a computing system related with a vehicle control device or a vehicle control method, according to an embodiment of the present disclosure.

### DETAILED DESCRIPTION

Hereinafter, embodiments of the present disclosure are described in detail with reference to the accompanying drawings. In adding the reference numerals to the components of each drawing, it should be noted that the identical or equivalent components are designated by the identical numerals even when the components are displayed on different drawings. Further, in describing the embodiment of the present disclosure, a detailed description of well-known features or functions has been omitted in order not to unnecessarily obscure the gist of the present disclosure.

In describing the components of the embodiment according to the present disclosure, terms such as first, second, “A”, “B”, (a), (b), or the like may be used. These terms are merely intended to distinguish one component from another component. The terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings equal to the contextual meanings in the relevant field of art. The terms should not be interpreted as having ideal or excessively formal meanings unless clearly defined as having such in the present disclosure.

In the following description, when a component, device, element, or the like of the present disclosure is described as having a purpose or performing an operation, function, or the like, the component, device, or element should be considered herein as being “configured to” meet that purpose or perform that operation or function.

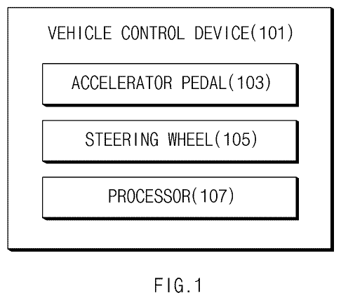

Hereinafter, embodiments of the present disclosure are described in detail with reference to FIGS. 1-7.

FIG. 1 is a block diagram showing a configuration of a vehicle control device, according to an embodiment of the present disclosure.

A vehicle control device 101 according to an embodiment of the present disclosure may be implemented inside or outside a vehicle. For example, some of the components included in the vehicle control device 101 may be implemented inside or outside the vehicle.

Referring to FIG. 1, the vehicle control device 101 may include at least one of an accelerator pedal 103, a steering wheel 105, a processor 107, or any combination thereof. At least one of the accelerator pedal 103, the steering wheel 105, the processor 107, or any combination thereof may be electronically and/or operably coupled with each other by an electronic component, such as a communication bus.

In the present disclosure, combining pieces of hardware operatively may mean a direct connection or an indirect connection between the pieces of hardware being established in a wired or wireless manner such that first hardware of the pieces of hardware is controlled by second hardware of the pieces of hardware. The type and/or number of hardware components included in the vehicle control device 101 is not limited to that shown in FIG. 1. For example, the vehicle control device 101 may include only some of the hardware components shown in FIG. 1.

According to an embodiment, the accelerator pedal 103 may be operated by a driver to specify an acceleration of a host vehicle. The steering wheel 105 may be operated by the driver to specify the driving direction of the host vehicle.

According to an embodiment, the processor 107 of the vehicle control device 101 may control the driving status of the host vehicle based on the accelerator pedal 103 and the steering wheel 105. For example, the processor 107 of the vehicle control device 101 may obtain a driver input for acceleration through the accelerator pedal 103, and may accelerate the host vehicle based on the driver input for acceleration. As another example, the processor 107 of the vehicle control device 101 may obtain a driver input to change the driving direction of the host vehicle through the steering wheel 105, and may change the driving direction of the host vehicle based on the driver input to change the driving direction.

According to an embodiment, the processor 107 of the vehicle control device 101 may identify whether the host vehicle is under autonomous driving control or driver assistance control. When a host vehicle having an existing vehicle control device is under autonomous driving control or under driver assistance control, the speed of the host vehicle may not be controlled based on the value of an acceleration identified according to the amount of operation of the accelerator pedal 103 even when the driver operates the accelerator pedal 103. This is because, when a host vehicle having an existing vehicle control device is under autonomous driving control or under driver assistance control, the accelerator pedal 103 may be operated by the user not by intention.

According to an embodiment, to improve usability, when the driver operates the accelerator pedal 103, the processor 107 of the vehicle control device 101 may allow the driver to take over control of operation (also sometimes referred to herein as “control of driving”) of the host vehicle according to the amount of operation of the accelerator pedal 103. The control of operation (e.g., control of driving) of the host vehicle may include control of the driving direction of the host vehicle and/or control of the driving speed of the host vehicle.

However, in a situation in which there is an accident risk, the processor 107 of the vehicle control device 101 according to an embodiment may not allow the driver to take over control of operation of the host vehicle when the driver operates the accelerator pedal 103. The situation in which there is an accident risk may include a situation where the operation of the accelerator pedal 103 is not due to the user's intention, or a situation where there is a risk of collision with an external object (e.g., a preceding vehicle).

In an embodiment, the processor 107 of the vehicle control device 101 may identify whether at least one condition is satisfied to identify whether the accident risk is less than a reference value. The at least one condition may include at least one of i) a condition for identifying whether the amount of operation of the accelerator pedal 103 is less than or equal to a value indicative of a specified amount of operation, ii) a condition for identifying the driver input of gripping the steering wheel 105, iii) a condition for identifying whether the driver's gazes are directed toward the front of a vehicle, or iv) a condition for identifying whether the value of deceleration at which the host vehicle is controlled is less than or equal to a specified value, or any combination thereof.

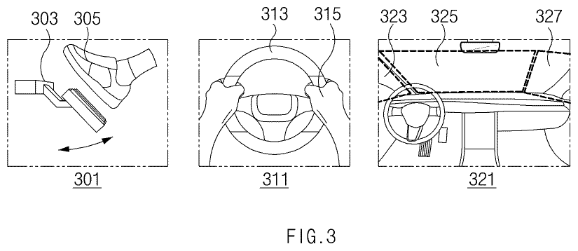

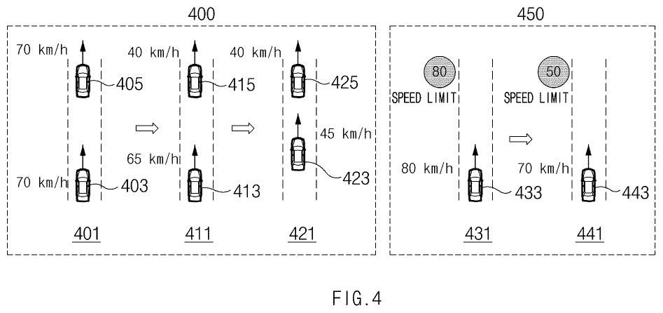

Conditions for identifying whether the accident risk is less than a reference value are described in more detail below with reference to FIGS. 3 and 4.

According to an embodiment, when the host vehicle is controlled to accelerate under autonomous driving control or under driver assistance control, the processor 107 of the vehicle control device 101 may allow a driver to take over control of operation of the host vehicle according to the amount of operation of the accelerator pedal, based on identifying that the value of an acceleration identified by the amount of operation is greater than the value of an acceleration at which the host vehicle is controlled either under autonomous driving control or under driver assistance control.

This is because it is consistent with the user's intention to allow the driver to take over control of operation of the host vehicle according to the amount of operation of the accelerator pedal only when the value of the acceleration identified according to the amount of operation is greater than the value of the acceleration at which the host vehicle is controlled either under autonomous driving control or under driver assistance control.

When the host vehicle is controlled to decelerate under autonomous driving control or under driver assistance control, the processor 107 of the vehicle control device 101 may allow the driver to take over control of operation of the host vehicle according to the amount of operation of the accelerator pedal.

This is because it is consistent with the user's intention to allow the driver to take over control of operation of the host vehicle according to the amount of operation of the accelerator pedal without comparing the value of the acceleration at which the host vehicle is controlled with the value of the acceleration identified according to the amount of operation when the accelerator pedal is operated, because the vehicle is controlled to decelerate.

According to another embodiment, the processor 107 of the vehicle control device 101 may allow the driver to take over control of operation of the host vehicle based on identifying that the value of an acceleration identified according to the amount of operation of the accelerator pedal is greater than or equal to a threshold value.

This is because a probability that the user has unintentionally operated the accelerator pedal is higher than a probability that the user has intentionally operated the accelerator pedal when the value of an acceleration identified according to the amount of operation of the accelerator pedal is less than the threshold value.

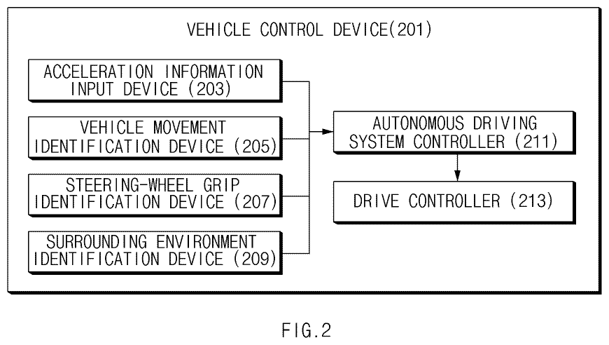

FIG. 2 is a block diagram illustrating a configuration of a vehicle control device in more detail, according to an embodiment of the present disclosure.

A vehicle control device 201 according to an embodiment of the present disclosure may be implemented inside or outside a vehicle. For example, some of the components included in the vehicle control device 201 may be implemented inside or outside the vehicle.

Referring to FIG. 2, the vehicle control device 201 may include at least one of an acceleration information input device 203, a vehicle movement identification device 205, a steering-wheel grip identification device 207, a surrounding environment identification device 209, an autonomous driving system controller 211, a drive controller 213, or any combination thereof. At least one of the acceleration information input device 203, the vehicle movement identification device 205, the steering-wheel grip identification device 207, the surrounding environment identification device 209, the autonomous driving system controller 211, the drive controller 213, or any combination thereof may be electrically and/or operatively connected to each other by electronic components, such as a communication bus.

The type and/or number of hardware components included in the vehicle control device 201 is not limited to that shown in FIG. 2. For example, the vehicle control device 101 may include only some of the hardware components shown in FIG. 2.

According to an embodiment, a processor of the vehicle control device 201 may identify whether an accident risk is less than a reference value when the driver takes over control of driving of a vehicle based on information identified by the acceleration information input device 203, the vehicle movement identification device 205, the steering-wheel grip identification device 207, and the surrounding environment identification device 209.

According to an embodiment, the vehicle control device 201 may allow the driver to take over control of driving of the vehicle based on the operation of the accelerator pedal performed by the driver when the accident risk is less than the reference value when the driver takes over control of driving of the vehicle. When the driver takes over control of driving of the vehicle, the drive controller 213 may control the speed of the host vehicle at an acceleration identified based on the amount of pedal operation by the driver.

According to an embodiment, the acceleration information input device 203 may identify the amount of operation of the accelerator pedal. For example, the acceleration information input device 203 may identify the amount of change in position of the accelerator pedal through a position sensor. However, embodiments of the present disclosure are not limited thereto.

According to an embodiment, the vehicle movement identification device 205 may identify the speed, deceleration, and acceleration of the host vehicle.

According to an embodiment, the steering-wheel grip identification device 207 may identify the driver's steering wheel grip state. For example, the steering-wheel grip identification device 207 may identify a strength of the driver input of gripping a steering wheel. In an example, the steering-wheel grip identification device 207 may identify whether the steering wheel is gripped by one hand, gripped by both hands, or not gripped. The steering-wheel grip identification device 207 may include a touch sensor included in the steering wheel. Additionally, or alternatively, the steering-wheel grip identification device 207 may include a torque sensor included in the steering wheel.

According to an embodiment, the surrounding environment identification device 209 may identify the location or speed of an external object. For example, the surrounding environment identification device 209 may identify the location and speed of a surrounding vehicle.

According to an embodiment, the autonomous driving system controller 211 may determine the driving speed or driving direction of the host vehicle based on the location or speed of an external object obtained from the surrounding environment identification device 209. The autonomous driving system controller 211 may transmit setting values required for driving to the drive controller 213 based on information necessary for driving, such as the surrounding environment, legal conditions, and road conditions.

According to an embodiment, the drive controller 213 may operate the host vehicle based on a drive command received from the autonomous driving system controller 211.

FIG. 3 shows examples of conditions determined to reduce an accident risk in a vehicle control device or vehicle control method, according to an embodiment of the present disclosure.

Referring to FIG. 3, in a first situation 301, an accelerator pedal 303 may be operated by a driver 305. In a second situation 311, a steering wheel 313 may be gripped by a driver 315. In a third situation 321, the gazes of the driver may be directed to one of a first area 323, a second area 325, or a third area 327.

According to an embodiment, in the first situation 301, a processor of the vehicle control device may identify a value indicative of a specified amount of operation to determine whether a condition for identifying whether the amount of operation of the accelerator pedal 303 is less than or equal to the value indicative of the specified amount of operation is satisfied.

Because an accident risk is high when the amount of operation of the accelerator pedal 303 is greater than the value indicative of the specified amount of operation, the processor of the vehicle control device may determine whether to allow a driver to take over control of driving of the host vehicle based on the amount of operation of the accelerator pedal 303.

For example, the value indicative of the specified amount of operation may be identified to have a correlation in which the value indicative of the specified amount of operation increases as the speed of the host vehicle increases. This is because the lower the speed of the host vehicle, the higher the probability that a distance to a preceding vehicle is closer. Therefore, the lower the speed of the host vehicle, the smaller the value indicative of the specified amount of operation to allow the driver to take over control of driving of the vehicle.

In an embodiment, the value indicative of the specified amount of operation may be identified based on a range of the amount of operation of the accelerator pedal 303 for which a collision avoidance system is operated, where the collision avoidance system provides a warning, brakes the host vehicle, or controls the driving direction of the host vehicle to avoid a collision between the host vehicle and an external object (e.g., a preceding vehicle). The collision avoidance system may refer to a forward collision-avoidance assist (FCA). However, embodiments of the present disclosure are not limited thereto.

The collision avoidance system may be operated when the amount of operation of the accelerator pedal 303 is within a specified range of amount of operation (e.g., a range from about 0% to about 70% of the range in which the accelerator pedal 303 can be operated). Accordingly, the processor of the vehicle control device may allow the driver to take over control of driving of the vehicle only when the amount of operation of the accelerator pedal 303 is within the range of the amount of operation of the accelerator pedal 303 for which the collision avoidance system is operated, to allow the collision avoidance system to be continuously operated although the driver takes over control of driving of the vehicle. The amount of operation of the accelerator pedal 303 may include the amount of change in the position of the accelerator pedal 303.

In the second situation 311, the processor of the vehicle control device may identify whether a driver input of gripping the steering wheel 313 is received to identify whether the condition for identifying whether the driver input of gripping the steering wheel 313 is satisfied.

The processor of the vehicle control device may determine whether to allow the driver to take over control of driving of the vehicle based on whether the driver grips the steering wheel 313 because there is a high probability that the operation of the accelerator pedal identified while the driver does not grip the steering wheel 313 is not due to the user's intention.

According to an embodiment, the processor of the vehicle control device may identify the input of the driver 315 through a touch sensor included in the steering wheel 313 and/or through a torque sensor included in the steering wheel 313.

According to an embodiment, the touch sensor may include a capacitive sensor or a static pressure sensor. The touch sensor may refer to a grip detection sensor. However, embodiments of the present disclosure are not limited thereto.

According to an embodiment, the processor of the vehicle control device may determine whether to allow the driver to take over control of driving of the vehicle based on not only whether the steering wheel 313 is gripped but also a strength of the grip.

In the third situation 321, the processor of the vehicle control device may identify the direction in which the driver's gaze is directed to identify whether the condition for identifying whether the driver's gaze is directed toward the front of the vehicle is satisfied.

The processor of the vehicle control device may determine whether to allow the driver to take over control of driving of the vehicle based on the direction of the driver's gazes because the operation of the accelerator pedal identified while the driver's gaze is not directed toward the front of the vehicle is highly likely not to be due to the user's intention.

According to an embodiment, the processor of the vehicle control device may identify a point to which the driver's gaze is directed on the windshield of the host vehicle through a camera for acquiring an image including the driver. The processor of the vehicle control device may allow the driver to take over control of driving of the host vehicle when the host vehicle is under autonomous driving control or under driver assistance control, based on identifying that the point to which the driver's gaze is directed is included in the second area 325 that is a specified area on the windshield.

According to an embodiment, when the point to which the driver's gaze is directed is included in the first area 323 or the third area 327, the processor of the vehicle control device may not allow the drier to take over control of driving of the vehicle although the accelerator pedal is operated.

FIG. 4 shows examples of conditions determined to reduce an accident risk in a vehicle control device or vehicle control method, according to an embodiment of the present disclosure.

Referring to FIG. 4, in a first phase 401 of a first situation 400, a host vehicle 403 and a preceding vehicle 405 may drive at the same speed. In a second phase 411 of the first situation 400, the host vehicle 413 may decelerate according to the preceding vehicle 415 that is rapidly decelerating. In a third phase 421 of the first situation 400, the host vehicle 423 may decelerate according to the preceding vehicle 425 driving at a constant speed to a smaller deceleration than the host vehicle 413 in the second phase 411.

According to an embodiment, in the first situation 400, the processor of the vehicle control device may identify a specified value to identify whether a condition for identifying whether the value of the deceleration at which the host vehicle is controlled based on the autonomous driving control or the driver assistance control is less than or equal to the specified value is satisfied.

The processor of the vehicle control device may determine whether to allow the driver to take over control of driving of the host vehicle based on the value of the deceleration of the host vehicle because there is a high accident risk if the host vehicle accelerates when the value of the deceleration at which the host vehicle is controlled based on the autonomous driving control or the driver assistance control is greater than the specified value.

For example, the specified value may be identified to have a correlation in which the specified value increases as the speed of the host vehicle increases. This is because the lower the speed of the host vehicle, the higher the probability that a distance to a preceding vehicle is closer.

According to an embodiment, the value of the deceleration at which the host vehicle is controlled based on the autonomous driving control or the driver assistance control may be identified based on at least one of a distance to a preceding object (e.g., a preceding vehicle) of the host vehicle, a predicted remaining time to collision, or any combination thereof. The predicted remaining time to collision may refer to a time to collision (TTC). However, embodiments of the present disclosure are not limited thereto. The predicted remaining time to collision may be identified based on i) a difference between the speed of the preceding object (e.g., preceding vehicle) and the speed of the host vehicle and ii) a distance between the preceding object and the host vehicle.

According to an embodiment, in the first phase 401 of the first situation 400, a processor of the vehicle control device of the host vehicle 403 driving at a constant speed may decelerate to a first deceleration value (e.g., about 0 m/s²). A first value may be identified as a specified value. The processor of the vehicle control device may identify the first value as the specified value. In the first phase 401 of the first situation 400, the processor of the vehicle control device may allow the driver to take over control of driving of the host vehicle according to the operation of the accelerator pedal.

According to an embodiment, in the second phase 411 of the first situation 400, the host vehicle 413 may decelerate to a second deceleration value (e.g., about −20 m/s²) to prevent a collision with a preceding vehicle 415 that is rapidly decelerating. A processor of the vehicle control device of the host vehicle 413 may identify a second value smaller than the first value as a specified value. In the second phase 411 of the first situation 400, the processor of the vehicle control device may not allow the driver to take over control of driving of the host vehicle according to the operation of the accelerator pedal.

According to an embodiment, in the third phase 421 of the first situation 400, to prevent a collision with the preceding vehicle 425 driving at a constant speed, the host vehicle 413 may decelerate to a third deceleration (e.g., about −10 m/s²) having a value smaller than the value of the second deceleration. A processor of the vehicle control device of the host vehicle 423 may identify a third value smaller than the second value as a specified value. In the third phase 421 of the first situation 400, the processor of the vehicle control device may allow the driver to take over control of driving of the host vehicle according to the operation of the accelerator pedal.

In the second situation 450, the processor of the vehicle control device may identify a case in which the driver is allowed to take over control of operation of the host vehicle even when the value of the deceleration at which the host vehicle is controlled is greater than a specified value.

According to an embodiment, when the value of the deceleration is determined based on at least one of a maximum speed set by the driver, a speed specified by law, a deceleration specified regardless of a preceding object of the host vehicle, or any combination thereof, the processor of the vehicle control device may allow the driver to take over control of driving of the host vehicle in spite of the autonomous driving control or the driver assistance control even when the value of the deceleration at which the host vehicle is controlled based on the autonomous driving control or the driver assistance control is greater than the specified value.

According to an embodiment, the maximum speed set by the driver may include a speed specified by the driver as the maximum speed for driving under the autonomous driving control or under the driver assistance control. The speed specified by law may include a speed limit. The deceleration specified regardless of a preceding object of the host vehicle may include a deceleration that is set for a purpose other than avoiding collision with the preceding object in the autonomous driving system or the driver assistance system.

According to an embodiment, in the first phase 431 of the second situation 450, the host vehicle 433 may drive at a constant speed. In the second phase 441 of the second situation 450, the host vehicle 443 may drive at a reduced speed according to the legal speed limit. However, because in the second phase 441 of the second situation 450, the value of the deceleration at which the host vehicle is controlled is determined based on the speed specified by law, the processor of the vehicle control device may allow the driver to take over control of driving of the host vehicle when other conditions are satisfied although the value of the deceleration at which the host vehicle is controlled based on the autonomous driving control or the driver assistance control is greater than the specified value.

Therefore, the processor of the vehicle control device in the first phase 431 of the second situation 450 and the processor of the vehicle control device in the second phase 441 of the second situation 450 may allow the driver to take over control of driving of the host vehicle according to the operation of the accelerator pedal.

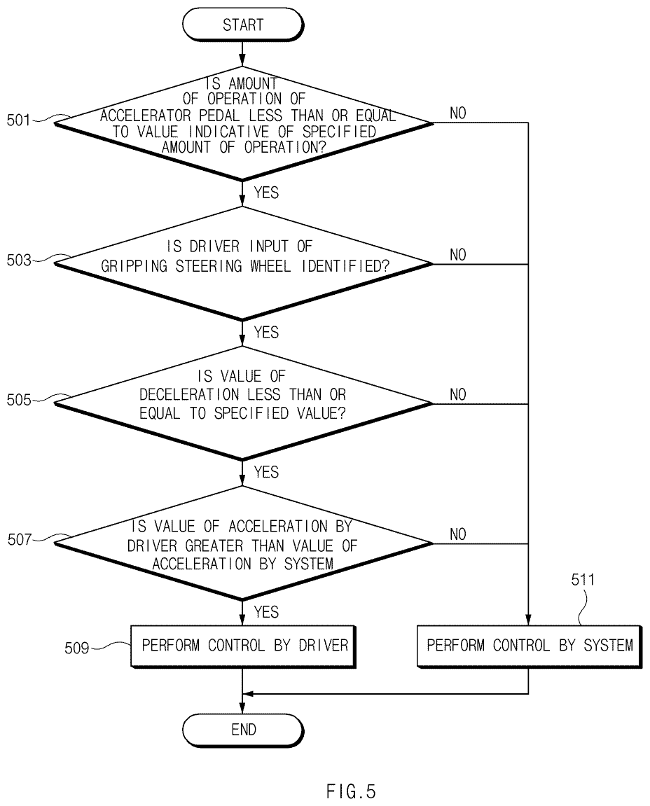

FIG. 5 illustrates a flowchart of operation of a vehicle control device for determining whether to perform control according to a driver input in a vehicle control device or a vehicle control method, according to an embodiment of the present disclosure.

Hereinafter, it is assumed that the vehicle control device 101 of FIG. 1 performs the process of FIG. 5. Additionally, in the description of FIG. 5, operations described as being performed by the vehicle control device may be understood as being controlled by the processor 107 of the vehicle control device 101.

Referring to FIG. 5, in an operation 501, the processor of the vehicle control device may identify whether the amount of operation of an accelerator pedal is less than or equal to a value indicative of a specified amount of operation. When the amount of operation of the accelerator pedal is less than or equal to the value indicative of the specified amount of operation, the processor of the vehicle control device may perform an operation 503. On the other hand, when the amount of operation of the accelerator pedal is greater than the value indicative of the specified amount of operation, the processor of the vehicle control device may perform an operation 511. The amount of operation of the accelerator pedal may include the amount of change in the position of the accelerator pedal.

According to an embodiment, the value indicative of the specified amount of operation may be identified to have a correlation in which the value indicative of the specified amount of operation increases as the speed of the host vehicle increases. This is because the lower the speed of the host vehicle, the higher the probability that a distance to a preceding vehicle is closer.

According to an embodiment, the value indicative of the specified amount of operation may be included in a range of the amount of operation of the accelerator pedal which a collision avoidance system operates, where the collision avoidance system provides a warning, brakes the host vehicle, or controls the driving direction of the host vehicle to avoid a collision between the host vehicle and an external object (e.g., a preceding vehicle). This is because an accident risk increases when the collision prevention system is not implemented.

In the operation 503, the processor of the vehicle control device may determine whether a driver input of gripping the steering wheel is identified. When the driver input of gripping the steering wheel is identified, the processor of the vehicle control device may perform an operation 505. On the other hand, when the driver input of gripping the steering wheel is not identified, the processor of the vehicle control device may perform the operation 511.

The processor of the vehicle control device may determine whether to allow the driver to take over control of operation of the host vehicle based on whether the driver grips the steering wheel because there is a high probability that the operation of the accelerator pedal identified while the driver does not grip the steering wheel is not due to the user's intention.

In the operation 505, the processor of the vehicle control device may identify whether the value of deceleration of the host vehicle is less than or equal to a specified value. When the value of the deceleration is less than or equal to the specified value, the processor of the vehicle control device may perform an operation 507. On the other hand, when the value of the deceleration is greater than the specified value, the processor of the vehicle control device may perform the operation 511.

The processor of the vehicle control device may determine whether to allow the driver to take over control of driving of the host vehicle based on the value of deceleration of the host vehicle because there is a high accident risk if the host vehicle accelerates when the value of deceleration at which the host vehicle is controlled based on the autonomous driving control or the driver assistance control is greater than the specified value.

In the operation 507, the processor of the vehicle control device may identify whether the value of acceleration by the driver is greater than the value of acceleration by the system. When the value of acceleration by the driver is greater than the value of acceleration by the system, the processor of the vehicle control device may perform an operation 509. On the other hand, when the value of acceleration by the driver is smaller than the value of acceleration by the system, the processor of the vehicle control device may perform the operation 511.

According to another embodiment, the processor of the vehicle control device may identify that the value of acceleration by the driver is greater than a threshold value without identifying whether the value of acceleration by the driver is greater than the value of acceleration by the system. When the value of acceleration by the driver is greater than or equal to the threshold value, the processor of the vehicle control device may perform the operation 509. On the other hand, when the value of the acceleration by the driver is less than the threshold value, the processor of the vehicle control device may perform the operation 511.

In the operation 509, the processor of the vehicle control device may perform control by the driver. In other words, the processor of the vehicle control device may allow the driver to take over control of driving of the host vehicle. The control of driving of the host vehicle may include control of the driving direction of the host vehicle or control of the driving speed of the host vehicle.

In the operation 511, the processor of the vehicle control device may perform control by the system. In other words, the processor of the vehicle control device may allow an autonomous driving system or a driver assistance-based system to control driving of the host vehicle.

In FIG. 5, in the operation 503, when the driver input of gripping the steering wheel is identified, the vehicle control device is shown as performing the operation 505. However, the present disclosure is limited thereto. According to an embodiment, in the operation 503, when the driver input of gripping the steering wheel is identified, the vehicle control device may perform the operation 507.

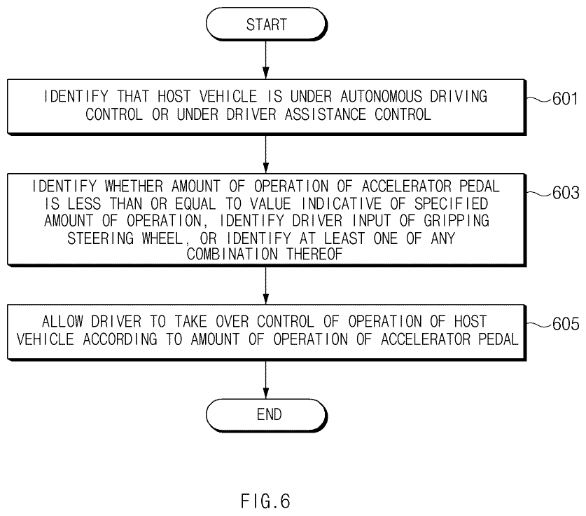

FIG. 6 illustrates a flowchart of operation of a vehicle control device for performing control according to a driver input in a vehicle control device or vehicle control method, according to an embodiment of the present disclosure.

Hereinafter, it is assumed that the vehicle control device 101 of FIG. 1 performs the process of FIG. 6. Additionally, in the description of FIG. 6, operations described as being performed by the vehicle control device may be understood as being controlled by the processor 107 of the vehicle control device 101.

Referring to FIG. 6, in an operation 601, the processor of the vehicle control device may identify whether the host vehicle is under autonomous driving control or driver assistance control.

In an operation 603, the processor of the vehicle control device may identify at least one of whether an amount of operation of an accelerator pedal is less than or equal to a value indicative of a specified amount of operation, a driver input of gripping a steering wheel, or any combination thereof.

In an operation 605, the processor of the vehicle control device may allow the driver to take over control of operation of (e.g., control of driving of) the host vehicle according to the amount of operation of the accelerator pedal. In an embodiment, the processor of the vehicle control device may control the host vehicle to allow the driver to take over control of operation of the host vehicle according to the amount of operation of the accelerator pedal when the host vehicle is under autonomous driving control or under driver assistance control, based on identifying that the amount of operation of the accelerator pedal is less than the value indicative of a specified amount of operation and/or identifying the driver input of gripping a steering wheel.

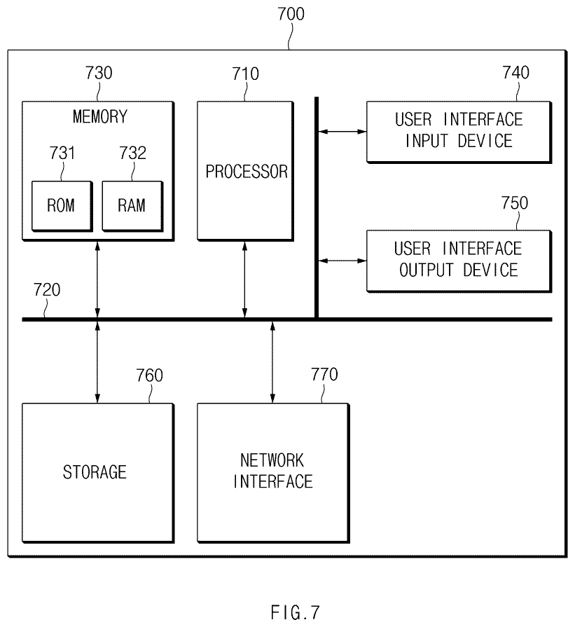

FIG. 7 illustrates a computing system related with a vehicle control device or a vehicle control method, according to an embodiment of the present disclosure.

Referring to FIG. 7, a computing system 700 may include at least one processor 710, a memory 730, a user interface input device 740, a user interface output device 750, storage 760, and a network interface 770, which are connected with each other via a bus 720.

The processor 710 may be a central processing unit (CPU) or a semiconductor device that processes instructions stored in the memory 730 and/or the storage 760. The memory 730 and the storage 760 may include various types of volatile or non-volatile storage media. For example, the memory 730 may include a ROM (Read Only Memory) 731 and a RAM (Random Access Memory) 732.

Thus, the operations of the method or the algorithm described in connection with the embodiments disclosed herein may be embodied directly in hardware or a software module executed by the processor 710, or in a combination thereof. The software module may reside on a storage medium (e.g., the memory 730 and/or the storage 760) such as a RAM, a flash memory, a ROM, an EPROM, an EEPROM, a register, a hard disk, a removable disk, and/or a CD-ROM.

The storage medium may be coupled to the processor 710. The processor 710 may read information out of the storage medium and may record information in the storage medium. Alternatively, the storage medium may be integrated with the processor 710. The processor 1100 and the storage medium may reside in an application specific integrated circuit (ASIC). The ASIC may reside within a user terminal. In another case, the processor 1100 and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

Accordingly, the embodiments disclosed in the present disclosure are not intended to limit the technical idea of the present disclosure but to describe the present disclosure. The scope of the technical idea of the present disclosure is not limited by the described embodiments. The scope of protection of the present disclosure should be interpreted by the appended claims, and all technical ideas within the scope equivalent thereto should be construed as being included in the scope of the present disclosure.

Embodiments of the present disclosure may identify whether an input for accelerating a vehicle is based on the driver's intention based on the driver input of gripping a steering wheel during autonomous driving control or driver assistance control.

Embodiments of the present disclosure may identify whether an input for accelerating a vehicle is due to the driver's intention based on the driver's gaze during autonomous driving control or driver assistance control.

Embodiment of the present disclosure may reduce an accident risk due to an input for accelerating a vehicle during autonomous driving control or driver assistance control.

In addition, various effects may be provided that are directly or indirectly understood by though having ordinary skill in the art from the present disclosure.

Hereinabove, although the present disclosure has been described with reference to certain embodiments and the accompanying drawings, the present disclosure is not limited thereto. The present disclosure may be variously modified and altered by those having ordinary skill in the art to which the present disclosure pertains without departing from the spirit and scope of the present disclosure claimed in the appended claims.

What is claimed is:

1. A vehicle control device comprising:
an accelerator pedal configured to specify an acceleration of a host vehicle;
a steering wheel configured to specify a driving direction of the host vehicle; and
a processor configured to
identify that the host vehicle is under autonomous driving control or driver assistance control, and
control the host vehicle to allow a driver to take over control of driving of the host vehicle according to an amount of operation of the accelerator pedal based on at least one of
i) identifying whether an amount of operation of the accelerator pedal is less than or equal to a value indicative of a specified amount of operation, when the host vehicle is under the autonomous driving control or under the driver assistance control or
ii) identifying a driver input of gripping a steering wheel.

2. The vehicle control device of claim 1, wherein the processor is configured to control the host vehicle to allow the driver to take over control of driving of the host vehicle according to the amount of operation of the accelerator pedal based on identifying that a value of deceleration at which the host vehicle is controlled under the autonomous driving control or under the driver assistance control is less than or equal to a specified value, when the host vehicle is under the autonomous driving control or under the driver assistance control.

3. The vehicle control device of claim 1, wherein the processor is configured to control the host vehicle to allow the driver to take over control of driving of the host vehicle according to the amount of operation of the accelerator pedal based on identifying that gaze of the driver is directed toward front of the host vehicle, when the host vehicle is under the autonomous driving control or under the driver assistance control.

4. The vehicle control device of claim 3, further comprising:
a camera configured to acquire an image including the driver,
wherein the processor is configured to
identify a point to which the gaze of the driver is directed on a windshield of the host vehicle through the camera, and
control the host vehicle to allow the driver to take over control of driving of the host vehicle according to the amount of operation of the accelerator pedal based on identifying that the point is included a specified area on the windshield, when the host vehicle is under the autonomous driving control or under the driver assistance control.

5. The vehicle control device of claim 1, wherein the processor is configured to:
control the host vehicle to allow the driver to take over control of driving of the host vehicle according to the amount of operation of the accelerator pedal based on identifying that a value of acceleration identified according to the amount of operation of the accelerator pedal is greater than a value of acceleration at which the host vehicle is controlled under the autonomous driving control or under the driver assistance control, when the host vehicle is controlled to accelerate under the autonomous driving control or under the driver assistance control; and
control the host vehicle to allow the driver to take over control of driving of the host vehicle according to the amount of operation of the accelerator pedal when the host vehicle is controlled to decelerate under the autonomous driving control or under the driver assistance control.

6. The vehicle control device of claim 1, wherein the processor is configured to control the host vehicle to allow the driver to take over control of driving of the host vehicle when a value of acceleration identified according to the amount of operation of the accelerator pedal is greater than a threshold value.

7. The vehicle control device of claim 1, wherein the processor is configured to identify a speed of the host vehicle, and wherein the value indicative of the specified amount of operation of the accelerator pedal has a correlation in which the value indicative of the specified amount of operation increases as the speed of the host vehicle increases.

8. The vehicle control device of claim 2, wherein the processor is configured to identify a speed of the host vehicle, and wherein the specified value has a correlation in which the specified value increases as the speed of the host vehicle increases.

9. The vehicle control device of claim 2, wherein the processor is configured to identify the value of deceleration at which the host vehicle is controlled under the autonomous driving control or under the driver assistance control based on at least one of a distance between the host vehicle and a preceding object, a difference between a speed of the preceding object and a speed of the host vehicle, or any combination thereof.

10. The vehicle control device of claim 2, wherein the processor is configured to control the host vehicle to allow the driver to take over control of driving of the host vehicle according to the amount of operation of the accelerator pedal, when the host vehicle is under the autonomous driving control or under the driver assistance control, when the value of deceleration is determined based on at least one of a maximum speed set by the driver, a speed specified by law, a deceleration specified regardless of a preceding object of the host vehicle, or any combination thereof, even when the value of the deceleration at which the host vehicle is controlled is greater than the specified value.

11. The vehicle control device of claim 1, wherein the processor is configured to:
identify a driver input through a touch sensor included in the steering wheel, or
identify the driver input through a torque sensor included in the steering wheel.

12. The vehicle control device of claim 1, wherein the processor is configured to identify the value indicative of the specified amount of operation of the accelerator pedal based on a range of the amount of operation of the accelerator pedal that a collision avoidance system is configured to operate,
wherein the collision avoidance system is configured to provide a warning, brake the host vehicle, or control a driving direction of the host vehicle to avoid a collision between the host vehicle and an external object.

13. A vehicle control method comprising:
identifying that a host vehicle is under autonomous driving control or under driver assistance control; and
controlling the host vehicle to allow a driver to take over control of driving of the host vehicle according to an amount of operation of an accelerator pedal when the host vehicle is under the autonomous driving control or under the driver assistance control based on at least one of i) identifying whether the amount of operation of the accelerator pedal is less than or equal to a value indicative of a specified amount of operation or ii) identifying a driver input of gripping a steering wheel.

14. The vehicle control method of claim 13, wherein controlling the host vehicle to allow the driver to take over control of driving of the host vehicle according to the amount of operation of the accelerator pedal includes controlling the host vehicle to allow the driver to take over control of driving of the host vehicle according to the amount of operation of the accelerator pedal based on identifying that a value of deceleration at which the host vehicle is controlled under the autonomous driving control or under the driver assistance control is less than or equal to a specified value, when the host vehicle is under the autonomous driving control or under the driver assistance control.

15. The vehicle control method of claim 13, wherein controlling the host vehicle to allow the driver to take over control of driving of the host vehicle according to the amount of operation of the accelerator pedal includes controlling the host vehicle to allow the driver to take over control of driving of the host vehicle according to the amount of operation of the accelerator pedal based on identifying that gaze of the driver is directed toward a front of the host vehicle even when the host vehicle is under the autonomous driving control or under the driver assistance control.

16. The vehicle control method of claim 15, wherein controlling the host vehicle to allow of the driver to take over control of driving of the host vehicle according to the amount of operation of the accelerator pedal based on identifying that the gaze of the driver is directed toward the front of the host vehicle includes:
identifying a point to which the gaze of the driver is directed on a windshield of the host vehicle through a camera; and
controlling the host vehicle to allow the driver to take over control of driving of the host vehicle according to the amount of operation of the accelerator pedal based on identifying that the point is included in a specified area on the windshield, when the host vehicle is under the autonomous driving control or under the driver assistance control.

17. The vehicle control method of claim 13, wherein controlling the host vehicle to allow the driver to take over control of driving of the host vehicle according to the amount of operation of the accelerator pedal includes
controlling the host vehicle to allow the driver to take over control of driving of the host vehicle according to the amount of operation of the accelerator pedal based on identifying that a value of acceleration identified according to the amount of operation of the accelerator pedal is greater than a value of acceleration at which the host vehicle is controlled under the autonomous driving control or under the driver assistance control, when the host vehicle is controlled to accelerate under the autonomous driving control or under the driver assistance control; and
controlling the host vehicle to allow the driver to take over control of driving of the host vehicle according to the amount of operation of the accelerator pedal when the host vehicle is controlled to decelerate under the autonomous driving control or under the driver assistance control.

18. The vehicle control method of claim 13, wherein controlling the host vehicle to allow the driver to take over control of driving of the host vehicle according to the amount of operation of the accelerator pedal includes controlling the host vehicle to allow the driver to take over control of driving of the host vehicle when a value of acceleration identified according to the amount of operation of the accelerator pedal is greater than a threshold value.

19. The vehicle control method of claim 13, further comprising:
identifying a speed of the host vehicle,
wherein the value indicative of the specified amount of operation has a correlation in which the value indicative of the specified amount of operation increases as the speed of the host vehicle increases.

20. The vehicle control method of claim 14, further comprising:
identifying a speed of the host vehicle,
wherein the specified value has a correlation in which the specified value increases as the speed of the host vehicle increases.
